(19) United States
(12) Patent Application Publication
(10) Pub. No.: US 2019/0030851 A1
(43) Pub. Date: Jan. 31, 2019

(54) METHOD AND APPARATUS FOR PROVIDING A WEB OF A FLEXIBLE, PLASTIC PACKAGING MATERIAL AND FLEXIBLE POUCH PACKAGE

(71) Applicant: ECOLEAN AB, Helsingborg (SE)

(72) Inventors: Lars RODMAN, Bjärred (SE); Lars Peter NILSSON, Hellebaek (DK)

(21) Appl. No.: 16/085,675

(22) PCT Filed: Feb. 14, 2017
(86) PCT No.: PCT/EP2017/053241

§ 371 Date: Sep. 17, 2018

(30) Foreign Application Priority Data
Mar. 17, 2016 (EP) 16160911.0

(51) Int. Cl. B31B 70/855; B31B 70/00; B31B 70/88; B65D 75/00; B65D 75/56; B65D 75/58

(52) U.S. Cl. CPC B31B 70/857; B31B 70/25; B31B 70/88; B31B 2155/00; B65D 75/563; B65D 75/5894; B65D 75/008

(57) ABSTRACT

A method for providing a web (30) of flexible, plastic packaging material with a succession of dimples (9) forming indentations for straw insertion, comprising feeding the web (30) of packaging material through a first nip (52) defined by a first pair (51) of rotating rollers, and cyclically engaging the web (30) from a first side (31) by a protrusion (55) supported by a first roller (53) of said first pair (51) of rotating rollers for forming the succession of dimples (9) in the web (30) of packaging material. The invention also relates to a corresponding apparatus and a flexible pouch package comprising a dimple.

### FIELD OF THE INVENTION

The present invention relates to a method and an apparatus for providing a web of a flexible, plastic packaging material, and more specifically to such a method and apparatus for providing the web with a succession of dimples constituting indentations for straw insertion as well as a flexible pouch package made of the flexible, plastic packaging material and provided with a dimple forming an indentation for straw insertion.

### BACKGROUND ART

Many different types of packages for liquid contents are currently available.

One type of package is of pouch type and comprises two side walls which are flexible and joined along a connecting portion to form a compartment, whose volume is dependent on the relative position of the walls. The pouch type package may be of stand-up pouch type and may then also comprise a bottom wall.

This type of packages may, before filling, be in a flat and sealed state. This makes it possible to sterilise the compartment of the packages in connection with manufacture and, with maintained sterility, distribute the packages to a filling plant, such as a dairy, to be filled.

The package may be of a size suitable for immediate consumption, such as having a volume in the range of 80-400 ml. The package may be provided with straw to be used for consumption of the contents.

The straw may be inserted into the package via the side wall of the package. The side wall may be provided with a weakening in order to facilitate the insertion of the straw.

U.S. Pat. No. 7,175,581 discloses a pouch type package having a dimple formed in one of its side walls. The package is formed of a web of flexible material such as plastic film. The dimple is formed in a mould under heat and pressure to weaken the film.

FR2849802 discloses a device for local deformation of a packaging film material for forming a dimple for straw insertion. The device comprises a punch being pressed against the film material. The film material is multilayered wherein the different layers have different tensile strengths. The tensile strengths of the layers are chosen such that a top layer of the film is stretched until it breaks during the forming of the dimple.

A device for forming recesses in a sheet material is known from DE4334364.

In view of the above, there is a demand for an improved process for providing a web of flexible, plastic packaging material with a succession dimples forming indentations for straw insertion.

### SUMMARY OF THE INVENTION

In view of that stated above, the object of the present invention is to provide an improved method and apparatus for providing a web of a flexible, plastic packaging material with a succession of dimples.

It is also an object to provide such a method and apparatus that enables a high production capacity.

A further object is to provide such a method and apparatus that enables high repeatability during operation, i.e. that the dimples formed have uniform characteristics.

Another object is to provide an improved flexible pouch package provided with a dimple.

To achieve at least one of the above objects and also other objects that will be evident from the following description a method having the features defined in claim 1, an apparatus having the features defined in claim 5 and a flexible pouch package having the features defined in claim 11 are provided according to the present invention. Preferred embodiments of the method and the apparatus will be evident from the dependent claims.

More specifically, according to a first aspect of the present invention there is provided a method for providing a web of a flexible, plastic packaging material with a succession of dimples forming indentations for straw insertion. The method comprises feeding the web of the packaging material through a first nip defined by a first pair of rotating rollers and cyclically engaging the web from a first side by a protrusion supported by a first roller of said first pair of rotating rollers for forming the succession of dimples in the web of packaging material.

The inventive method enables efficient provision of dimples in a web of packaging material. The method has high repeatability, ensuring uniform characteristics of the dimples.

The dimples (forming depressions/indentations) are provided by means of the protrusion cyclically engaging the web being fed through the first nip. Thus a succession of dimples may be provided in the web of packaging material in a continuous process. The inventive method enables a high production capacity. For instance, a production rate in the range of 2 000-6 000 dimples/minute is conceivable.

The dimples are formed by the protrusion cyclically engaging and locally deforming the web of the flexible, plastic packaging material. It may be ensured that the protrusions engage the web such that the flexible, plastic packaging material is stretched sufficiently in order to form the dimples by plastic deformation of the packaging material.

The first roller may support one protrusion, and then one dimple will be formed for each revolution of the first roller. The first roller may of course support additional circumferentially distributed protrusions, with a correspondingly number of dimples being formed for each revolution of the first roller.

The inventive method allows for an easy change of pitch, i.e. change of the distance between two successively formed dimples, by adjusting the radial distance between the protrusion and the centre of rotation of the first roller. In order for the pitch to be easily changed, the protrusion may be supported by a section mounted on the first roller. When a new pitch is desired, the section is replaced with another providing the desired distance between the protrusion and the centre of rotation.

According to an embodiment, the method may further comprise engaging the web from a second side opposite to the first side by an elastic surface member supported by a second roller of said first pair of rotating rollers for provision of a resilient abutment for the first roller. The elastic surface member may be provided with a recess or hole for reception of the protrusion when passing the first nip.

According to another embodiment, the method may further comprise clamping a portion of the web passing through the first nip between the first roller and the elastic surface member of the second roller while the protrusion engages the web. The clamping may be achieved by arranging the first and second roller at such a mutual distance that the elastic surface member is pressed and compressed against the envelope surface of the first roller when passing the first nip. As a consequence of the portion of the web being clamped, the formation of the dimple by means of deformation of the web may be achieved in a controlled manner during the protrusion's engagement with the web.

If the protrusion is supported by a section mounted on the first roller, the surface against which the elastic surface member is pressed may be provided by that section.

According to yet another embodiment, the method may further comprise feeding the web to a second nip defined by a second pair of rotating rollers and cyclically engaging the web from the first side by a knife member supported by a first roller of said second pair of rotating rollers for providing a succession of cuts in a top layer of the web at locations corresponding to the locations of the succession of dimples. The provision of a cut in the dimple will further facilitate the insertion of a straw through the dimple. The fact that the cut is provided only in the top layer of the web ensures that the integrity of the packaging material is maintained.

According to a second aspect of the present invention, an apparatus is provided for providing a web of a flexible, plastic packaging material with dimples forming indentations for straw insertion. The apparatus comprises a first pair of rotatable rollers defining a first nip, a first roller of said first pair of rotatable rollers comprising a protrusion arranged for cyclical engagement from a first side with the web being fed through the first nip for forming a succession of dimples in the web of the packaging material.

According to an embodiment of the second aspect of the present invention, the protrusion may comprise a semi spherical top portion arranged for engagement with the web for forming a dimple. The semi spherical shape of the top portion ensures a smooth and reliable, cyclic engagement of the protrusion with the web.

According to another embodiment, a second roller of said first pair of rotatable rollers may comprise an elastic surface member forming a resilient abutment for the first roller. The elastic surface member may be provided with a recession for reception of the protrusion of the first roller when the protrusion passes the first nip.

According to yet another embodiment, the first and second roller of the first pair of rotatable rollers may be arranged such that a portion of the web being fed through the first nip is clamped between the first roller and the elastic surface member of the second roller while the protrusion engages the web.

According to yet another embodiment, the apparatus may further comprise a second pair of rotatable rollers defining a second nip, a first roller of said second pair of rotatable rollers comprising a knife member arranged for cyclical engagement from the first side with the web being fed through the second nip for forming a succession of cuts in a top layer of the web at locations corresponding to the locations of the succession of dimples.

The details and advantages of the second aspect of the invention are largely analogous to those of the first aspect of the invention, wherein reference is made to the above.

According to a third aspect of the present invention, a flexible pouch package for liquid foodstuff is provided, comprising a side wall being provided with a dimple forming an indentation for facilitating insertion of a straw, wherein a cut is arranged in a top layer of the side wall at a location corresponding to the location of the dimple.

The dimple ensures reliable positioning of an end of the straw prior to insertion thereof through the side wall of the package, and the cut arranged in the dimple facilitates the insertion by reduction of the force required for penetrating the side wall with the straw.

It should be noted that within the context of this application, the term “flexible” packaging material is meant to describe a packaging material suitable for a pouch type package of stand-up type, i.e. a flexible package which volume is dependent on the filling ratio of the package.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a perspective view of a package in accordance with the present invention.

FIG. 2 is a perspective view of the package in FIG. 1 with a straw inserted through a side wall of the package.

FIGS. 3a-d are schematic plan views of a dimple provided with different types of cuts.

FIGS. 4a-b are schematic perspective views of an inventive apparatus for providing a web of packaging material with a succession of dimples.

FIGS. 5a-c are schematic side views illustrating the inventive method for providing a web of packaging material with a succession of dimples.

FIG. 6 is a schematic perspective view of an inventive apparatus for providing cuts in a succession of dimples.

FIG. 7 is a schematic cross sectional side view of the apparatus shown in FIG. 6.

### DESCRIPTION OF EMBODIMENTS

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

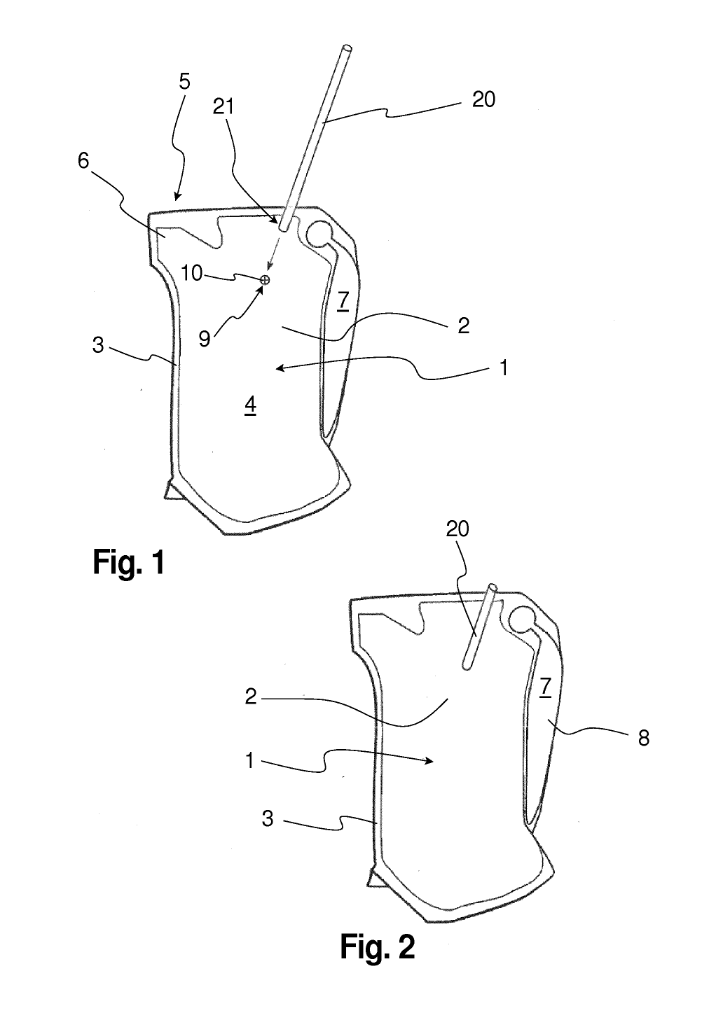

A pouch type package 1 of stand-up pouch type according to an embodiment of the invention is shown in FIG. 1, to which reference is made.

The package may be provided as a pre-made package adapted to be filled and sealed in a filling machine. Alternatively, the package may be produced fully or in part in the filling machine.

The package is especially intended for products in the form of liquid foodstuffs such as dairy products (e.g. milk), water, fruit drinks, juice or wine.

The package may be of any desirable volume. The volume may be chosen such that the contents are suitable for immediate consumption and may then be in the range of 80-400 ml.

The package 1 comprises three flexible walls, two of which constitute a first side wall 2 and second side wall; and the third constitutes a bottom wall. The second side wall and the bottom wall are not visible in the figure. The walls are joined along a connecting portion 3 to define a product compartment 4. The walls are made of a bendable and flexible, plastic material, which means that the volume of the product compartment 4 depends on the relative distance between the walls. The volume of the product compartment 4 is thus directly dependent on the filling ratio of the package 1. In other words, the package 1 is flexible and of a collapsible type, also referred to as a pouch type package.

The walls of the package 1 are preferably joined in the connecting portion 3 by welding. Also other methods of joining, such as gluing, are conceivable.

The shown package 1 has a top corner portion 5 which may be provided with an opening initiation along which a tab 6 may be separated for opening of the package. An opening is formed when the tab 6 is separated from the package 1 making the product compartment 4 communicate with the environment.

At the rear end of the package 1, a handle compartment 7 filled with gas and forming a handle 8 is shown. The handle compartment 7 is defined by the two side walls and the peripheral connecting portion 3. However, it is to be understood that the present invention also relates to packages provided with a handle of other types or not being provided with a handle at all.

As mentioned above, the handle compartment 7 is filled with gas in order to form a handle 8 of the package 1. By gas is preferably meant air, but of course also other gases may be used. The handle compartment 7 has such a geometry and filling ratio as to form an easy-to-grip handle 8 in inflated state. Such a handle 8 may also promote by its geometry and gas filling a considerable rigidity of the package 1.

The inventive package 1 further comprises a dimple 9 forming an indentation/depression provided in the first side wall 2 of the package 1. The purpose of the dimple 9 is to facilitate insertion of a straw 20 through the side wall 2 and into the product compartment 4 of the package 1. A non-penetrating cut 10 is further provided inside the dimple 9 and extending in a top layer only of the side wall 2.

In order to insert the straw 20 into the package 1, an end 21 of the straw 20 is placed in the dimple 9 and subsequently pushed through the side wall 2, as illustrated in FIGS. 1 and 2.

The presence of a dimple 9 provides reliable positioning of the straw and thus guidance for the straw insertion and the provision of a cut 10 inside the dimple 9 reduces the force required for the straw insertion.

The end 21 of the straw 20 may be pointed in order to further facilitate the insertion. It may be preferable to use a fairly rigid straw in order to avoid bending of the straw.

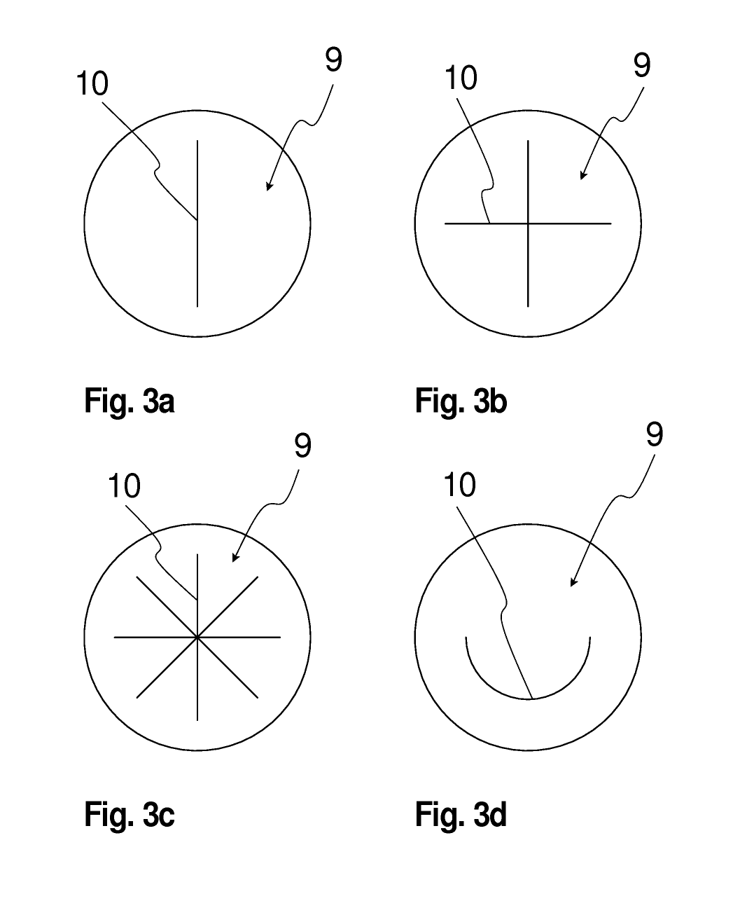

It is understood that the cut 10 in the dimple may be provided in different ways and some non-limiting embodiments are illustrated in FIGS. 3a-d. The cut 10 may thus be provided as a single line, as illustrated in FIG. 3a, as a cross, as illustrated in FIG. 3b, as a star, as illustrated in FIG. 3c, or as an arc, as illustrated in FIG. 3d.

The inventive package 1 is made from a web of a flexible, plastic packaging material which may be a multilayered film material. The film material may comprise a core layer of mineral-based filler and a binder of polyolefin. It will be appreciated that also other materials and layers are possible, such a gas barrier layer or a light barrier layer. The film material may also be a transparent packaging material, i.e. each of the layers making up the material is transparent.

For conversion of the web of the flexible, plastic packaging material into packages, the web may be folded in the shape of an M and subsequently be subjected to a sealing operation in order to provide a web of interconnected packages. The web may be wound up on a roll to be supplied to a filling machine where the packages are used as blanks to be filled with contents.

In accordance with the present invention, the dimples may be provided on the web before the web is converted into packages.

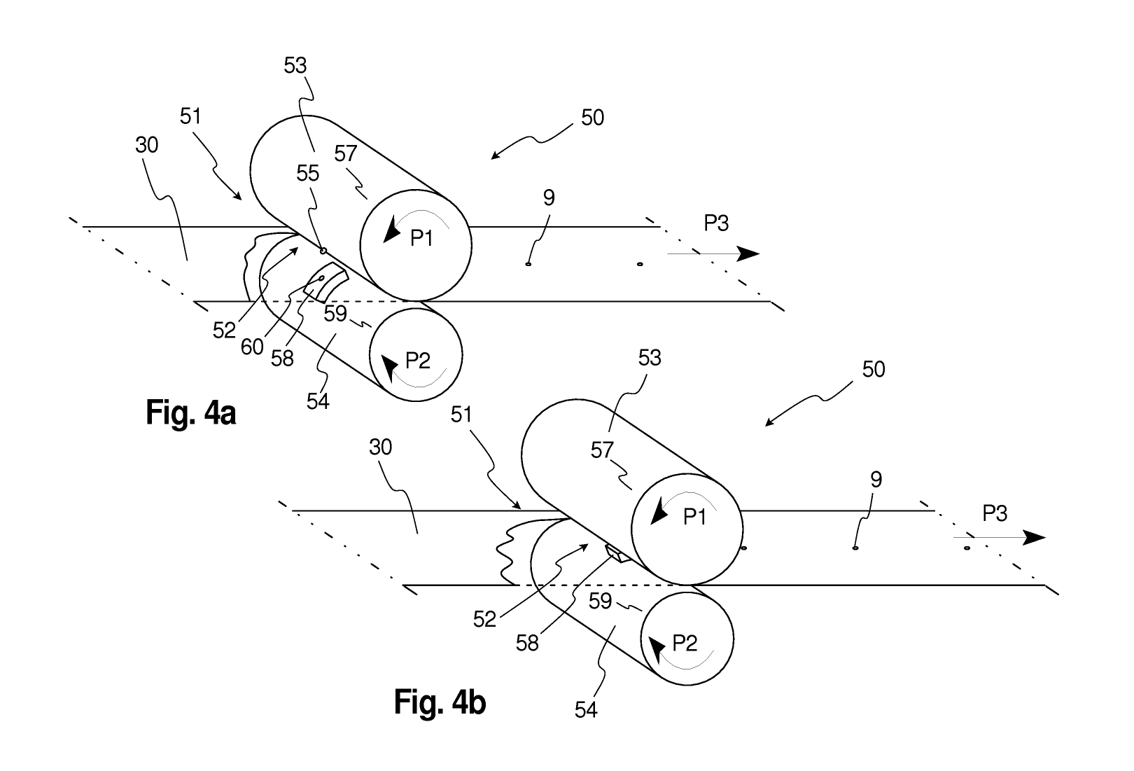

In FIGS. 4a and 4b, an apparatus 50 for providing a web 30 of packaging material with a succession of dimples 9 is illustrated.

The apparatus 50 comprises a first pair 51 of rollers defining a first nip 52. A first roller 53 and a second roller 54 of the first pair 51 of rollers are rotatable in directions indicated by arrows P1 and P2, respectively. Non disclosed means are provided for the rotation of the rollers 53, 54.

The first roller 53 of the first pair 51 of rollers supports a protrusion 55. The protrusion 55 is arranged for cyclic engagement with the web 30 of packaging material being fed through the first nip 52. The web 30 may be fed by means of a downstream situated bobbin (not shown), upon which the finished web 30 is wound up.

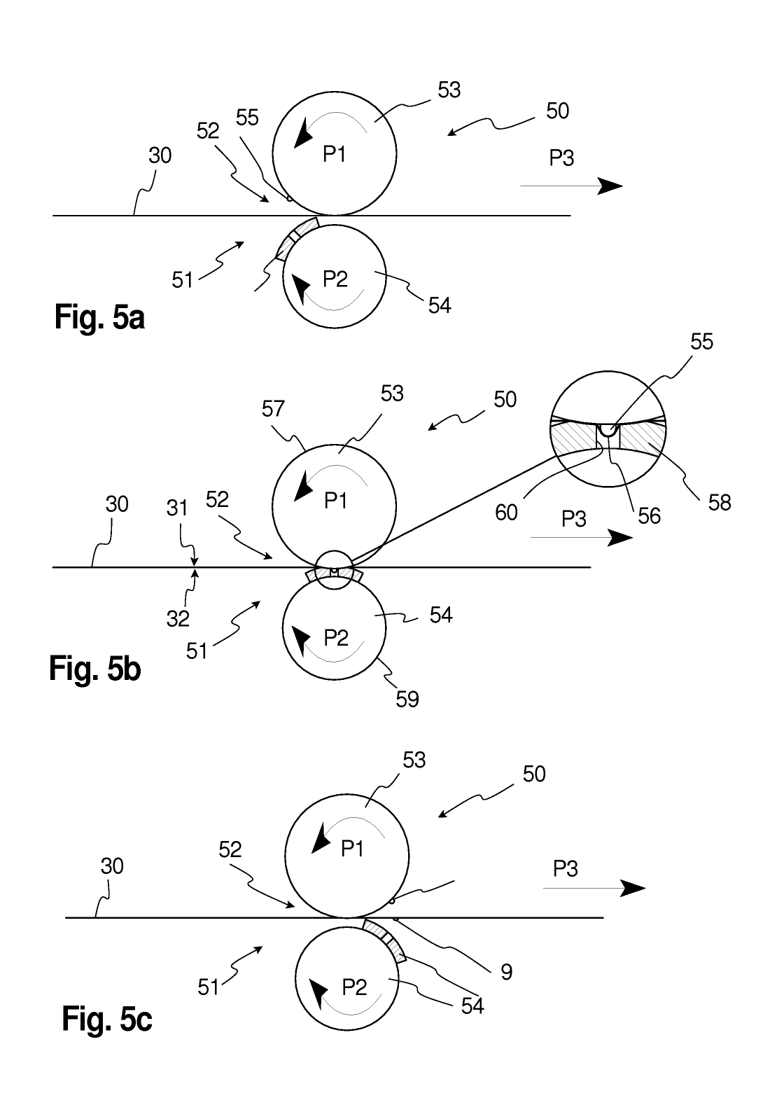

In the shown embodiment, the protrusion 55 is provided with a semi spherical top portion 56 (shown in more detail in FIG. 5b) such that an essentially semi spherical dimple 9 is formed when the protrusion 55 engages and locally deforms the web 30. However, other shapes of the top portion 56 are conceivable.

In the shown embodiment, the protrusion 55 is supported by the envelope surface 57 of the first roller 53. It is however appreciated that the protrusion may be supported by a section which in turn is mounted on the envelope surface of the first roller.

The second roller 54 of the first pair 51 of rollers supports an elastic surface member 58.

In the shown embodiment, the elastic surface member 58 is supported by the envelope surface 59 of the second roller 54. Hereby, replacement of the elastic surface member 58 is facilitated. Replacement of the elastic surface member may be caused by wear of failure. Also, a change of pitch may require replacement of the elastic surface member.

The elastic surface member 58 is provided with a recession 60. The recession 60 is arranged for reception of the protrusion 55 of the first roller 53 when the protrusion 55 passes the first nip 52 during operation of the apparatus 50.

The first and second rollers 53, 54 of the first pair 51 of rollers are arranged such that the elastic surface member 58 is pressed against the envelope surface 57 of the first roller 53 when the elastic surface member 58 passes the first nip 52. The elastic surface member 58 thus forms a resilient abutment for the first roller 53.

The elastic surface member 58 is made a suitable elastic material, such as rubber, and is compressed as the elastic surface member 58 is pressed against the envelope surface 57 of the first roller 53.

During operation of the inventive apparatus 50, the web 30 of the flexible, plastic packaging material is fed in the direction indicated by arrow P3 trough the first nip 52 defined by the first pair 51 of rollers which are rotated in the directions indicated by arrows P1 and P2. A portion of the web has been left out in FIGS. 4a and 4b for reasons of clarity.

The rotational speed or the rollers 53, 54 is adapted to the feeding rate of the web 30, such that there is no relative motion between the protrusion 55 and the web 30 during the protrusion's 55 engagement with the web 30.

In FIGS. 5a-c, to which reference now is made, the process for providing the web 30 with a dimple 9 is shown more in detail.

In order to carry out the process, the first pair 51 of rollers is rotated in the directions indicated by arrows P1 and P2 while the web 30 is fed in the direction indicated by arrow P3.

In FIG. 5a, the protrusion 55 of the first roller 53 and the elastic surface member 58 of the second roller 54 are shown in a rotational position upstream of the first nip 52.

In FIG. 5b, the protrusion 55 of the first roller 53 and the elastic surface member 58 of the second roller 54 have moved to a rotational position corresponding to the first nip 52. In this rotational position, the protrusion 55 engages the web 30 from a first side 31, while the elastic surface member 58 engages the web 30 from a second side 32, opposite to the first side 31. The protrusion 55 is received by the recession 60 provided in the elastic surface member 58, and as a result a dimple 9 is formed by means of local deformation of the web 30 of packaging material.

As has been described above, the elastic surface member 58 is pressed against the envelope surface 57 of the first roller 53 when passing the first nip 52. The elastic surface member 58 will thus be compressed and form a resilient abutment for the first roller 53 when passing the first nip 52. Consequently, in the first nip 52, a portion of the web 30 of packaging material will be clamped between the envelope surface 57 of the first roller 53 and the elastic surface member 58 of the second roller 54, which is shown more in detail in the detached enlargement in FIG. 5b. By clamping of the web 30 in the first nip 52, the deformation of the flexible, plastic packaging material occurring when the dimple 9 is formed due to the protrusion's 55 engagement with the web 30 will be controlled and restricted to the area of dimple. By selection of suitable properties of the flexible, plastic packaging material (e.g. thickness) and of the protrusion (e.g. size) it may be ensured that the packaging material during the engagement of the protrusion 55 is sufficiently stretched in order to cause a plastic deformation forming the dimple.

In FIG. 5c, the protrusion 55 and the elastic surface member 58 have been moved to a rotational position downstream of the first nip 52, and the dimple 9 previously formed in said first nip 52 is shown in a position downstream of said first nip 52.

By continued rotation of the first and second roller 53, 54 of the first pair 52 of rollers and continued feeding of the web 30, the protrusion 55 will cyclically engage the web 30 in the manner described above in order to provide the web 30 with a succession of dimples 9.

For a first roller supporting one protrusion, the mutual distance between two successive dimples, i.e. the pitch, is dependent on the radial distance between the protrusion and the centre of rotation of the first roller. If the protrusion is supported by a section mounted on the envelope surface of the first roller, the pitch may easily be changed by replacing the section with section having a different radial thickness. If the protrusion is arranged on a section mounted on the first roller, the surface used for clamping the web against the elastic surface member will be provided by that section.

Thus, in accordance with the present invention, a method is provided for providing a web of flexible, plastic packaging material with a succession of dimples forming indentations for straw insertion, comprising feeding the web of packaging material through the first nip defined by the first pair of rotating rollers, and cyclically engaging the web from the first side by the protrusion supported by the first roller of said first pair of rotating rollers for forming the succession of dimples in the web of packaging material.

By engaging the web from the second side opposite to the first side by the elastic surface member supported by the second roller of said first pair of rotating rollers a resilient abutment is provided for first roller.

A portion of the web passing through the nip while the protrusion engages the web is accordance to the shown embodiment clamped between the first roller and the elastic surface member of the second roller. The elastic surface member may be pressed against the envelope surface of the first roller or against a surface of a section mounted on the first roller. Hereby a controlled formation of a dimple by means of deformation of the web while the protrusion engages the same is provided.

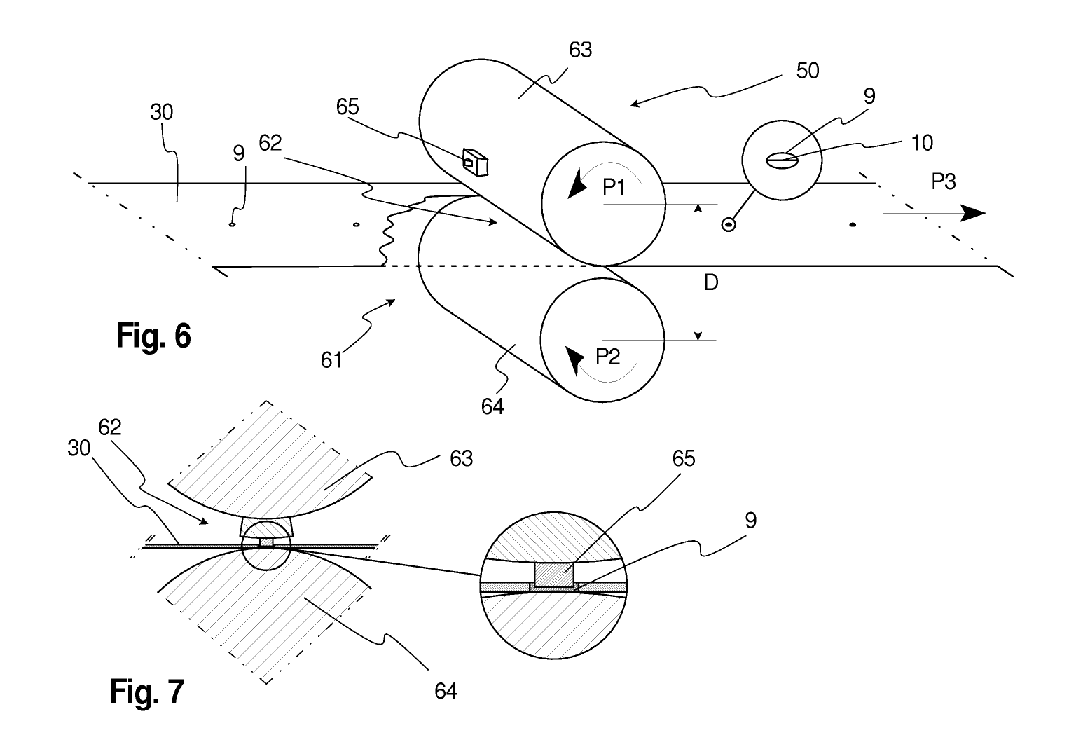

According to an embodiment, the inventive apparatus 50 may further comprise a second pair 61 of rollers defining a second nip 62. A schematic illustration of the second pair 61 of rollers is shown in FIG. 6. The second pair 61 of rollers comprises a first roller 63 and a second roller 64, which are rotatable in the directions indicated by arrows P1 and P2, respectively, and a web 30 of packaging material previously provided with a succession of dimples 9 is fed through the second nip 62 in the direction indicated by arrow P3. A portion of the web 30 downstream of the second nip 62 has been left out for reasons of clarity. Conventional means (not disclosed) are provided for rotation of the second pair 61 of rollers and for feeding of the web 30.

The second pair 61 of rollers may be arranged downstream of the first pair 51 of rollers. Alternatively, the second pair 61 of rollers may be arranged upstream of the first pair 51 of rollers.

The first roller 63 of the second pair 61 of rollers supports a knife member 65 arranged for cyclical engagement with the web 30 being fed through the second nip 62. More specifically, the knife member 65 is arranged for forming a succession of cuts 10 in a top layer of the web 30 at locations corresponding to those of the succession of dimples 9, as evident from the detached enlargement illustrating a dimple 9 downstream of the second pair 61 of rollers.

The engagement depth of the knife member 65 in the web 30 is controlled by the second roller 64 of the second pair 61 of rollers which acts as an abutment roller for the knife member 65. The engagement depth may thus be controlled by adjustment of the distance D between the first and second rollers 63, 64. According to an embodiment, the engagement depth is controlled such that a non-penetrating cut 10 is provided in a top layer of the web 30. The distance D between the first 63 and second 64 roller may be adjusted with high accuracy, and thus the engagement depth of the knife member 65 may also be adjusted with high accuracy.

In FIG. 7, a cross section is shown illustrating the engagement of the knife member 65 with the web 30 in the second nip 62, and it is evident from the detached enlargement that the engagement with the web 30 is non-penetrating such that a non-penetrating cut 10 is provided.

As mentioned above, the cut 10 is provided at a location corresponding to that of the dimple, and in FIG. 7 the dimple is schematically illustrated by the marked area having reference numeral 9.

In the shown embodiment, the cut 10 is arranged as a straight line, but as discussed above, the cut may be provided in other ways.

It will be appreciated that the present invention is not limited to the embodiments shown. Several modifications and variations are thus conceivable within the scope of the invention which thus is exclusively defined by the appended claims.

1. A method for making flexible pouch packages for liquid foodstuffs, each package having a dimple for straw insertion, the method comprising
providing a web of a flexible, plastic packaging material
converting the web of the flexible, plastic packaging material into packages, characterized in that
providing the web of the flexible, plastic packaging material comprises feeding the web of packaging material through a first nip defined by a first pair of rotating rollers,
cyclically engaging the web from a first side by a protrusion supported by a first roller of said first pair of rotating rollers for forming a succession of dimples in the web of packaging material, and engaging the web from a second side opposite to the first side by an elastic surface member supported by a second roller of said first pair of rotating rollers for provision of a resilient abutment for the first roller such that a portion of the web passing through the first nip is clamped between the first roller and the elastic surface member of the second roller while the protrusion engages the web.

2. The method according to claim 1, wherein providing the web of the flexible, plastic packaging material further comprises feeding the web to a second nip defined by a second pair of rotating rollers and cyclically engaging the web from the first side by a knife member supported by a first roller of said second pair of rotating rollers for providing a succession of cuts in a top layer of the web at locations corresponding to the locations of the succession of dimples.

3. Apparatus for providing a web of a flexible, plastic packaging material with dimples forming indentations for straw insertion, which web of the flexible, plastic packaging material is convertible into flexible pouch packages, the apparatus comprising a first pair of rotatable rollers defining a first nip, a first roller of said first pair of rotatable rollers comprising
a protrusion arranged for cyclical engagement from a first side with the web being fed through the first nip for forming a succession of dimples in the web of packaging material, and
a second roller of said first pair of rotatable rollers comprises an elastic surface member forming a resilient abutment for the first roller, wherein the first and second roller of the first pair of rotatable rollers are arranged such that a portion of the web being fed through the first nip is clamped between the first roller and the elastic surface member of the second roller while the protrusion engages the web.

4. The apparatus according to claim 3, wherein the protrusion comprises a semi spherical top portion arranged for engagement with the web for forming a dimple.

5. The apparatus according to claim 3, wherein the elastic surface member is provided with a recession for reception of the protrusion of the first roller when the protrusion passes the first nip.

6. The apparatus according to claim 3, further comprising a second pair of rotatable rollers defining a second nip, a first roller of said second pair of rotatable rollers comprising a knife member arranged for cyclical engagement from the first side with the web being fed through the second nip for forming a succession of cuts in a top layer of the web at locations corresponding to the locations of the succession of dimples.

7. A flexible pouch package for liquid foodstuff, comprising a side wall being provided with a dimple for facilitating insertion of a straw, wherein a cut is arranged in a top layer of the side wall at a location corresponding to the location of the dimple.

8. (canceled)

9. (canceled)

10. (canceled)

11. (canceled)
